(19) United States
(12) Patent Application Publication
(10) Pub. No.: US 2026/0148364 A1
(43) Pub. Date: May 28, 2026

(54) REAL-TIME IMAGE PROCESSING TO MEASURE SUBSTRATE OFFSETS AND APPLY CORRECTIONS TO ROBOT END EFFECTOR POSITIONING

(71) Applicant: Applied Materials, Inc., Santa Clara, CA (US)

(72) Inventors: Ying Yin Chang, Santa Clara, CA (US); Paul Z. Wirth, Kalispell, MT (US); Bindusagar Marath Sankarathodi, San Jose, CA (US); Carl Jehangir Canteenwala, San Jose, CA (US)

(21) Appl. No.: 18/957,056

(22) Filed: Nov. 22, 2024

(51) Int. Cl. G06T 7/00; B25J 19/02; G06T 1/00; G06T 3/60; G06T 7/13; G06T 7/60

(52) U.S. Cl. CPC G06T 7/0006; B25J 19/023; G06T 1/0014; G06T 3/60; G06T 7/13; G06T 7/60

(57) ABSTRACT

A system includes a substrate support configured to support and rotate a substrate a sensor positioned above the substrate support. Control logic causes the sensor to generate a images of an area of the substrate support and a portion of the substrate in a field of view of the sensor during rotation of the substrate support. Control logic performs edge detection by intensity-thresholding the images to identify a first edge of the substrate and a second edge of the substrate support. Control logic generates data representing a gap distance between the first and second edges and determines, from the data, a magnitude and a direction of an offset between a first center of the substrate support and a second center of the substrate. Control logic converts the offset to coordinates within a coordinate system of a robot and provides the coordinates to the robot.

### TECHNICAL FIELD

Some embodiments of the present disclosure relate to robot movements, and in particular, to real-time image processing to measure substrate offsets and apply corrections to a robot end effector positioning.

### BACKGROUND

A robot is used to place a substrate onto a substrate support within a processing chamber so that the substrate can be processed such as via film deposition, etching, or the like. In particular relation to film deposition, if the substrate is not centered on the substrate support, when the substrate support rotates, the film deposition can be unevenly applied. For example, the deposited film may be thinner near the edges of the substrate that extend beyond an intended central position on the substrate support.

For example, an uneven gap between the substrate edge and the edge of the substrate support can cause uneven thickness of growth around the substrate edge. Such uneven thickness can negatively impact the edge surface flatness (ESFQR) profile, which can affect downstream processes such as lithography and etch, causing tool downtimes and slower fabrication throughput. Lack of substrate uniformity can also decrease device performance and yield from the fabrication process.

### SUMMARY

Some embodiments described herein cover a system for processing substrates. For example, a system according to one embodiment includes a substrate support configured to support and rotate a substrate and a sensor positioned above the substrate support. Control logic can cause the sensor to generate a plurality of images of an area of the substrate support and a portion of the substrate in a field of view of the sensor during rotation of the substrate support. The control logic can perform edge detection using the plurality of images to identify a first edge of the substrate and a second edge of the substrate support. In embodiments, performing the edge detection using an image includes, for each of a plurality of scan lines within a region of interest in the image, determining a first point representing the first edge of the substrate and a second point representing the second edge of the substrate support based on applying one or more intensity thresholds. The control logic generates data representing a gap distance between the first edge and the second edge over time. The control logic determines, from the data, a magnitude and a direction of an offset between a first center of the substrate support and a second center of the substrate. The control logic converts the offset to a set of coordinates within a coordinate system of a robot that places the substrate and provides the set of coordinates to the robot for use in centering a next substrate on the substrate support.

In some embodiments, a method or corresponding computer-readable medium includes causing, by control logic of a processing system, a sensor to generate a plurality of images of an area of a substrate support and a portion of a substrate in a field of view of the sensor during rotation of the substrate support. The method includes performing, by the control logic, edge detection using the plurality of images to identify a first edge of the substrate and a second edge of the substrate support. In embodiments, wherein performing the edge detection using an image comprises, for each of a plurality of scan lines within a region of interest in the image, determining a first point representing the first edge of the substrate and a second point representing the second edge of the substrate support based on applying one or more intensity thresholds. The method includes generating data representing a gap distance between the first edge and the second edge over time. The method includes determining, from the data, a magnitude and a direction of an offset between a first center of the substrate support and a second center of the substrate. The method includes converting the offset to a set of coordinates within a coordinate system of a robot that places the substrate and providing, by the control logic, the set of coordinates to the robot for use in centering a next substrate on the substrate support.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one, but can make reference to multiple embodiments.

FIG. 1 is a schematic block diagram of an example processing system, including a sensor, according to some embodiments.

FIG. 2A is a top view depiction of a substrate and substrate support being imaged by a camera system according to some embodiments.

FIG. 2B is a graph illustrating a sinusoidal wave indicative of a magnitude and direction of a gap distance between edges of the substrate and the substrate support according to an embodiment.

FIG. 3 is a flow chart of an example method for determining an offset for use by a robot in centering the substrate on the substrate support according to some embodiments.

FIG. 4A is a flow chart of an example method for processing an image of a region of interest to facilitate edge detection according to some embodiments.

FIG. 4B is a flow chart of an example method for performing the edge detection using the processed image according to some embodiments.

FIG. 5 is a depiction of a substrate having a notch and various orientations and measurements with which to convert the offset to a coordinate system of the robot according to some embodiments.

FIG. 6 is a flow chart of an example method for converting the offset to the coordinate system of the robot according to some embodiments.

### DETAILED DESCRIPTION OF EMBODIMENTS

Embodiments of the present disclosure provide a system and method for determining an offset, for a robot, of a substrate that has been placed on a substrate support, which resolves the above-mentioned deficiencies in current substrate processing systems. For example, previously operators of the substrate processing system would manually center (e.g., using the human eye) the substrate within the substrate support. In this way, after processing a number of substrates, each subsequent substrate would be incrementally more centered. The substrate processing system, however, cannot run production during manual adjustment and the centered position is only an estimate based on manual observation by the operator. This approach, therefore, interrupts production flow, slows down substrate processing, and may still result in uneven deposition when the manual approach fails to adequately center the substrate on the substrate support.

Various embodiments of the present disclosure overcome these and other deficiencies by employing a sensor (e.g., image sensor or camera) to generate images of a particular region of interest illustrating the gap between edges of the substrate and the substrate support while the substrate support rotates (or spins). These images can be processed to identify a first edge of the substrate and a second edge of the substrate support. In embodiments, performing the edge detection using an image includes, for each of a plurality of scan lines within the region of interest in the image, determining a first point representing the first edge of the substrate and a second point representing the second edge of the substrate support based on applying one or more intensity thresholds. Several first points can form the first edge and several second points can form the second edge, for example.

In embodiments, once the first edge and the second edge are detected, data is generated (such as a relationship between the gap distance and time) that represents a magnitude and direction of an offset between a first center of the substrate support and a second center of the substrate over time. For example, the data can include a sinusoidal wave, a sinusoid, or sine or cosine wave in differing embodiments. In some embodiments, a plurality of offset values are calculated based on the data, which can be averaged and scaled to determine a single offset value associated with the region of interest.

By determining the offset value, e.g., as an X offset value and a Y offset value within a coordinate system of the sensor, this offset can be converted to a set of coordinates within a coordinate system of the robot. The set of coordinates can include a circumference distance to a center of an end effector and a robot rotation value for the robot to use in placing the next substrate to be processed onto the substrate support. In this way, computer-generated centering of the substrate ensures processing of substrates is not interrupted, eliminating human error, and leading to improved device performance and yield from the fabrication process.

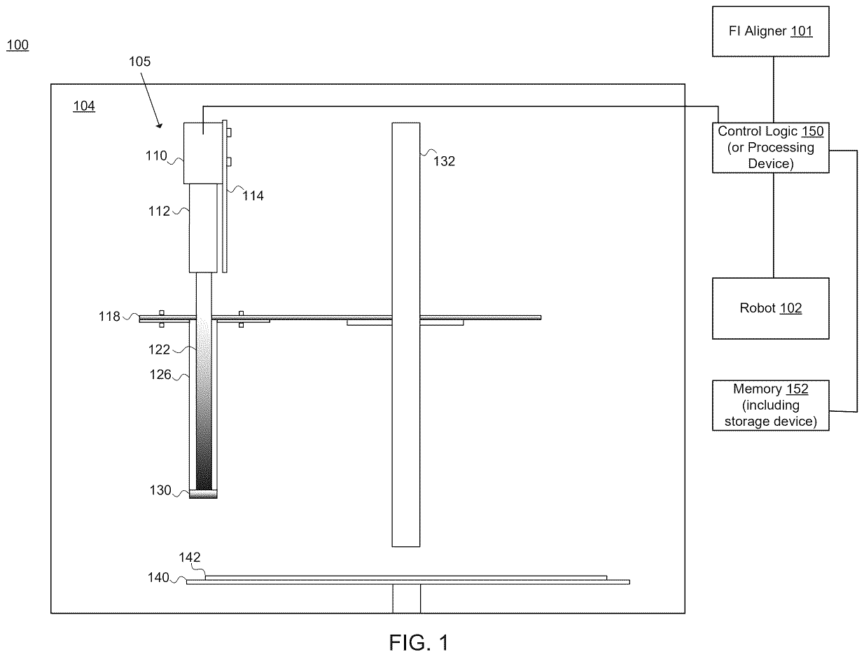

FIG. 1 is a schematic block diagram of an example processing system 100, including a camera, according to some embodiments. In embodiments, the processing system 100 includes an aligner 101 (e.g., such as a factory interface aligner that is disposed in a factory interface (FI)), a robot 102, a process chamber 104, and control logic 150 (or processing device) configured to execute instructions or otherwise control the robot 102 and operations performed within the process chamber 104, as will be described in detail. In some embodiments, the processing system 100 includes memory 152 coupled to the control logic 150, which can include volatile memory and optionally also non-volatile memory, such as a storage device. For example, the memory 152 can be a non-transitory computer-readable storage medium storing instructions, which when executed by the processing device (e.g., the control logic 150), cause the processing device to perform particular operations that will be discussed herein.

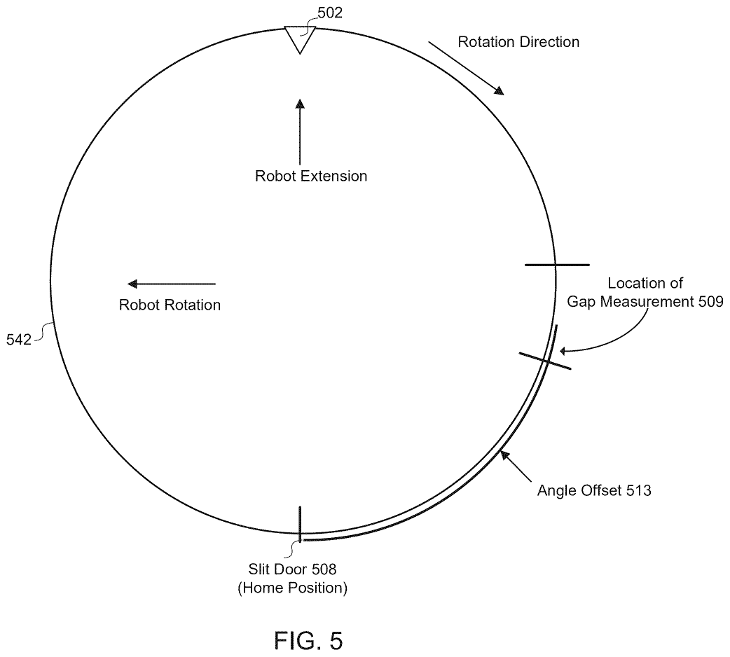

In various embodiments, the aligner 101 aligns each substrate entering the processing system 100, e.g., based on a position of a notch or flat of each substrate. Knowing this initial orientation will allow the robot 102 to insert each substrate in a consistent way having a same insertion axis into the process chamber 104. In embodiments, the robot 102 (which may include multiple robots, which may perform a handoff of the substrate, such as through a via or load lock station) transfers each substate through a transfer chamber, and through a slit valve or door of the process chamber 104 (see FIG. 5), and places the substrate onto a substrate support located inside of the process chamber 104. In some embodiments, the robot 102 that places the substrate into chamber 104 may be a robot of a transfer chamber.

In at least some embodiments, the process chamber 104 includes a camera system 105, a delivery tube 132, and a substrate support 140 onto which a substrate 142 is placed by the robot 102. In varying embodiments, the substrate support 140 can be a susceptor (e.g., which may include a susceptor pocket), a chuck (e.g., such as an electrostatic chuck a vacuum chuck, etc.), a heating pedestal, or other type of substrate support that is adapted to rotate or spin. The substrate 142 can be a wafer or other type of media (e.g., a plate such as a glass plate, which may have a circular shape in embodiments) capable of being processed into dies, such as for integrated circuits, transistors, photonic devices, radio frequency (RF) devices, or the like. In embodiments, the delivery tube 132 carries a reactive gas (e.g., precursors) for chemical vapor deposition (CVD), atomic or molecular beams of desired material for molecular beam epitaxy (MBE), or other compounds for other types of film growth or epitaxial deposition on the substrate 142.

In disclosed embodiments, the camera system 105 includes a sensor 110 (e.g., image sensor or camera capable of taking images), a light source 112 coupled to the sensor 110, a borescope 122 having a lengthened lens oriented towards the substrate support 140, and an infrared filter 130 attached to a bottom of the borescope 122. In embodiments, the borescope 122 is a specialized optical device used to inspect areas of the substrate support 140 and substrate 142 that are otherwise difficult or impossible to access directly. The borescope 122 can include a long, flexible or rigid tube with a camera or optical system at one end and an eyepiece or video display at the other end. The camera at the tip of the borescope 122 can be equipped with the light source 112 to illuminate dark or enclosed areas.

As further illustrated, the sensor 110 or camera can be attached to a mounting bracket 114, which itself can be attached to a wall or ceiling of the process chamber 104. The borescope 122 can be contained within a reflector tube 126 that is attached to a platform 118. In embodiments, the reflector tube 126 aids the borescope 122 in focusing on and capturing images within the process chamber 104 during substrate processing. In embodiments, the platform 118 is configured to stabilize and enable movement of the camera system 105 for purposes of focusing in on areas of interest (AOIs) of different-sized substrates.

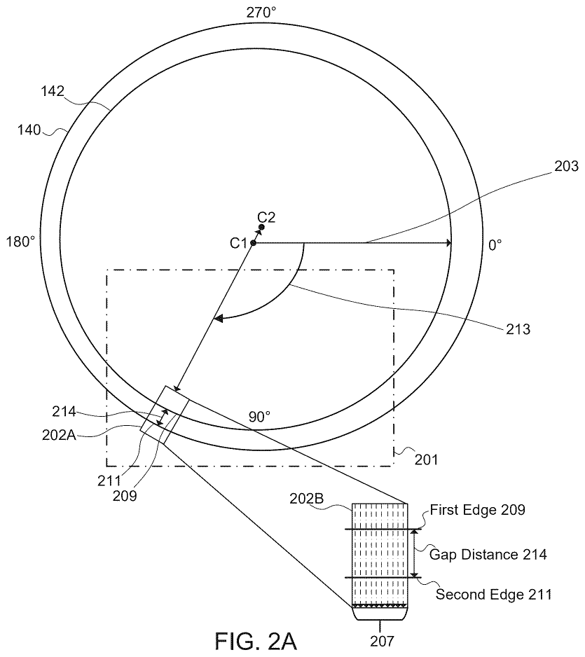

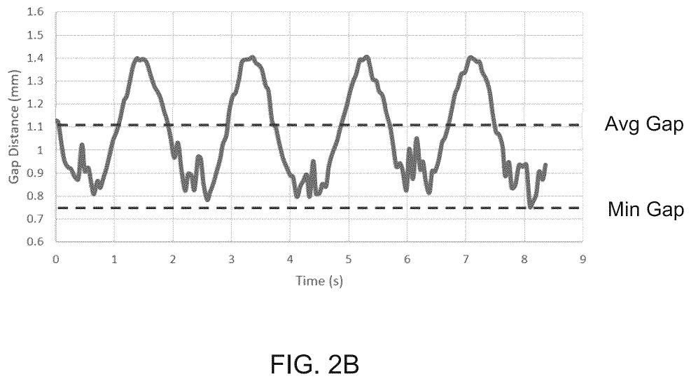

FIG. 2A is a top view depiction of the substrate 142 and substrate support 140 being imaged by the camera system 105, according to some embodiments. In a multi-dashed line, an area 201 is illustrated in a field of view of the camera system 105 (e.g., of the sensor 110) that covers portions of the substrate 142 placed on top of the substrate support 140. Just for purposes of explanation, the 360 degrees circumference of the substrate support 140 is indicated around the substrate support, which can be understood as associated with the process chamber 104 itself. Thus, the coordinate system of the camera system 105 may be rotated or adjusted to be consistent with that of the process chamber 104.

In some embodiments, the control logic 150 is directed to capture images focused on a region of interest 202A that overlaps the edges of the substrate 142 and substrate support 140. The control logic 150 can further determine a rotation angle 213 from an insertion axis of the substrate to the region of interest 202A. In embodiments, the insertion axis is associated with zero degrees (0°) of the process chamber 104, e.g., which corresponds to a location of a slit valve entry of substates to the process chamber 104. Although the rotation angle 213 is illustrated taken counter-clockwise from the insertion axis, the rotation angle 213 could also be taken clockwise from the insertion axis, so long as the control logic 150 understands a rotation axis relation to the coordinate system of the camera and chamber. The control logic 150 can rotate the image by the rotation angle 202 to create a rectangular image array 202B that is oriented vertically to be aligned with the chamber coordinate system. The control logic 150 can then identify the plurality of scan lines 207 across the rectangular image array 202B. A scan line may be a line in captured images that traverses the region of interest 202A from a substrate side to a substrate support side of the region of interest 202A.

In at least some embodiments, for each scan line, the control logic 150 scans pixels of the scan line from a substrate side to a substrate support side of the rectangular image array 202B associated with the region of interest 202A. The control logic 150 can identify a first point on a first edge 209 upon detecting a threshold drop in intensity of the pixels along a scan line. In embodiments, a combination of first points forms the first edge 209 (e.g., edge of the substrate 142). Further, the intensity of the pixels can refer to a light intensity captured by the sensor 110. Thus, the threshold drop in light intensity enables detecting a first dark line (e.g., the first edge 209) crossing through the rectangular image array 202B. The first edge 209 may be perpendicular or approximately perpendicular to the scan lines. The control logic 150 can identify a second point on a second edge 211 upon detecting a minimum intensity of the pixels. In embodiments, a combination of second points forms the second edge 211. The second edge 211 may be perpendicular or approximately perpendicular to the scan lines. The minimum intensity of the pixels can be understood as associated with a darkest line within the rectangular image array 202B (e.g., that is approximately perpendicular to the scan lines), which identifies the second edge 211 to be the edge of the substrate support 140.

With additional reference to FIG. 2B, FIG. 2B is a graph illustrating a sinusoidal wave indicative of a magnitude and direction of a gap distance 214 between edges of the substrate 142 and the substrate support 140 according to an embodiment, just for purposes of explanation, as the gap distance 214 can be expressed myriad relationships between gap distance and time. The sinusoidal wave (e.g., sine wave, sinusoid, or other such data) may show the gap distance 214 as a function of time and/or as a function of rotation angle of the substrate support. The greater the distance between peaks and valleys in the graphed sinusoidal wave, the greater the offset of a substrate center to a center of the substrate support. In embodiments, an average gap may be computed using the sinusoidal wave or related data. In this example, the sinusoidal wave generally varies between 0.8 millimeters (mm) and 1.4 mm, which enables identification of a minimum gap distance of 0.75 mm and an average gap distance of 1.1 mm. These values can, of course, vary in other contexts or applications, and thus are provided only by way of example.

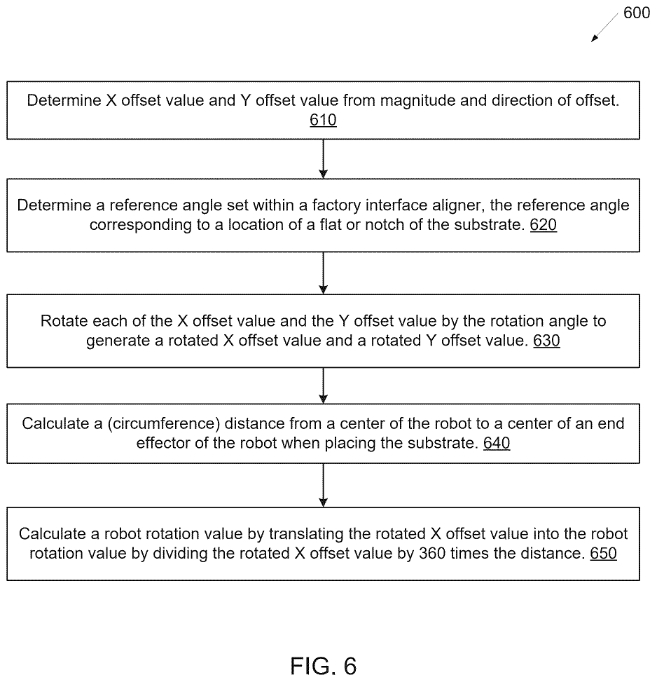

In embodiments, to determine the average gap distance, the control logic 150 calculates a plurality of offset values between first points of the first edge 209 and corresponding second points of the second edge 211. The control logic can then average the plurality of offset values and multiply the averaged value by a scaling factor to convert from pixels to a distance value (e.g., millimeters). The average gap distance can be used to determine an X offset value and a Y offset value within the camera coordinate system, e.g., by converting the average gap distance, using the direction of the gap distance 214, to the X offset value and the Y offset value corresponding to that magnitude and direction within the coordinate system of the camera. This average offset value can then be converted to the coordinate system of the robot 102, which will be discussed with reference to FIGS. 5-6. The robot 102 can then use the converted offset values to apply a correction to the location the robot 102 is directed to place a next substrate 142 on the substrate support 140. For example, the robot 102 can take the calculated offset values and add them to the chamber calibration. So, in one embodiment only by way of explanation, if the robot 102 had an original calibration of 150.0 degrees by 900.0 mm extension and an offset value of 0.1 degrees and 0.3 mm was calculated, then the new calibration would be 150.1 degrees by 900.3 mm extension.

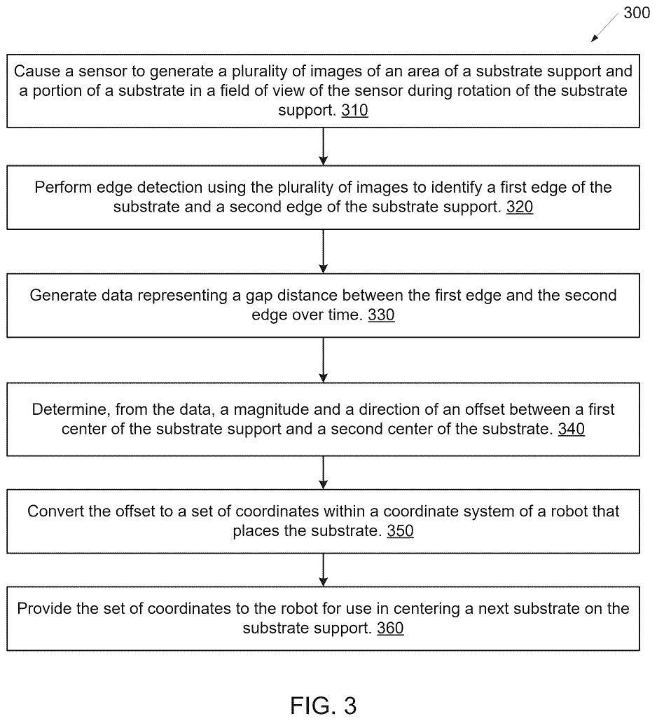

FIG. 3 is a flow chart of an example method 300 for determining an offset for use by the robot in centering the substrate on the substrate support according to some embodiments. The method 300 may be performed by processing logic that may include hardware (circuitry, dedicated logic, etc.), software (such as is run on a general purpose computer system or a dedicated machine), firmware, or some combination thereof. For example, the method 300 may be performed by the control logic 150 (or a processing device) of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic causes a sensor (e.g., the camera system 105) to generate a plurality of images of an area of a substrate support and a portion of a substrate in a field of view of the sensor during rotation of the substrate support. For example, the area can be the area 201 identified in FIG. 2A over a portion of the substrate support 140 and the substrate 142.

At operation 320, the processing logic performs edge detection using the plurality of images to identify a first edge of the substrate and a second edge of the substrate support. In some embodiments, performing the edge detection using an image includes, for each of a plurality of scan lines within a region of interest in the image, determining a first point representing the first edge of the substrate and a second point representing the second edge of the substrate support based on applying one or more intensity thresholds. In some embodiments, the processing logic also identifies the region of interest as a sub-area, located at edges of the substrate support 140 and the substrate 142, having a uniform lamp reflection from heat lamps of the process chamber 104.

At operation 330, the processing logic generates data (see FIG. 2B) representing a gap distance between the first edge and the second edge over time. In some embodiments, the gap distance is the gap distance 214 illustrated, by example, in FIG. 2B. For example, the data can be the result of an output of tracking the variation in the gap distance 214 over time.

At operation 340, the processing logic determines, from the data, a magnitude and a direction of an offset between a first center (C1 in FIG. 2A) of the substrate 142 and a second center (C2 in FIG. 2A) of the substrate support 140. This determination was discussed in detail with reference to FIGS. 2A-2B.

At operation 350, the processing logic converts the offset to a set of coordinates within a coordinate system of a robot that places the substrate. In embodiments, this conversion is discussed in detail with reference to FIGS. 5-6.

At operation 360, the processing logic provides the set of coordinates to the robot for use in centering a next substrate on the substrate support.

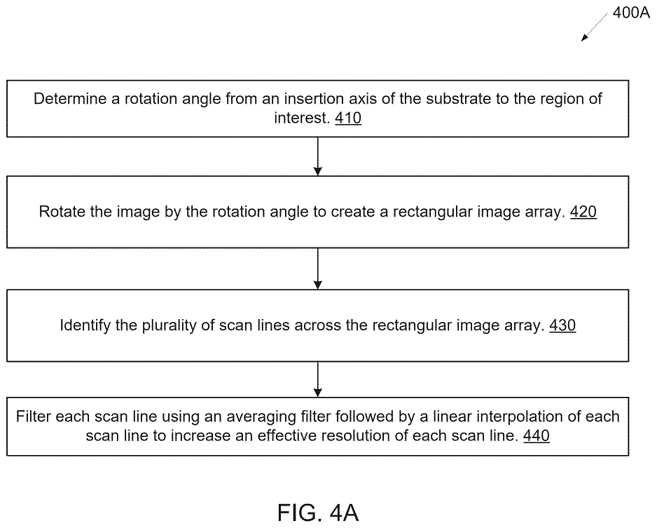

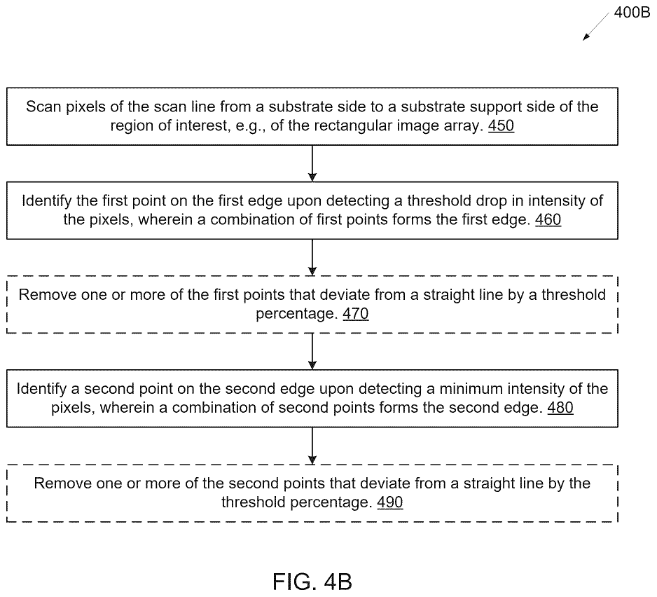

FIG. 4A is a flow chart of an example method 400A for processing an image of a region of interest to facilitate edge detection according to some embodiments. The method 400A may be performed by processing logic that may include hardware (circuitry, dedicated logic, etc.), software (such as is run on a general purpose computer system or a dedicated machine), firmware, or some combination thereof. For example, the method 400A may be performed by the control logic 150 (or a processing device) of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic determines a rotation angle from an insertion axis of the substrate to the region of interest. As discussed, the insertion axis is aligned with a direction the substrate 142 is inserted, which is also discussed with reference to the slit door 508 of FIG. 5.

At operation 420, the processing logic rotates the image by the rotation angle to create a rectangular image array, e.g., which is oriented vertically, as illustrated with reference to the rectangular image array 202B (FIG. 2). In this way, the pixels of the image are rotated to compensate for any rotation of the substrate 142 with reference to the insertion axis of the process chamber 104.

At operation 430, the processing logic identifies the plurality of scan lines across the rectangular image array 202B. This identification can include, for example, choosing a scan line every threshold number of pixels across an edge of a width the rectangular image array 202B, e.g., that resides on the extreme wafer side of the rectangular image array 202B.

At operation 440, the processing logic filters each scan line using an averaging filter followed by a linear interpolation of each scan line to increase an effective resolution of each scan line. This averaging filter and linear interpolation can employ particular image processing that is determined to emphasize identifying edges or lines within blurry images or images that lack clarity or sharpness of a certain degree.

FIG. 4B is a flow chart of an example method 400B for performing the edge detection using the processed image according to some embodiments. The method 400B may be performed by processing logic that may include hardware (circuitry, dedicated logic, etc.), software (such as is run on a general purpose computer system or a dedicated machine), firmware, or some combination thereof. For example, the method 400B may be performed by the control logic 150 (or a processing device) of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 450, the processing logic, for each scan line, scans pixels of the scan line from a substrate side to a substrate support side of the region of interest 202A, as illustrated in FIG. 2A. Scanning pixels can be understood as comparing light intensity with one or more thresholds in order to know when such thresholds are satisfied or otherwise met in a reminder of the operations of the method 400B.

At operation 460, the processing logic identifies the first point on the first edge 209 upon detecting a threshold drop in intensity of the pixels. In embodiments, a combination of first points forms the first edge 209. For example, the threshold drop in intensity can be an indication that each first point lies within the first edge 209 due to pixels of the first edge being a threshold amount in reduced light intensity compared to other pixels of the region of interest 202A or rectangular image array 202B.

At operation 470, the processing logic optionally removes one or more of the first points that deviate from a straight line by a threshold percentage, e.g., to ensure that outlier points are excluded from being considered valid points for the first edge 209. In differing embodiments, for example, the threshold percentage is between 15-30%.

At operation 480, the processing logic identifies a second point on the second edge 211 upon detecting a minimum intensity of the pixels. In embodiments, a combination of second points forms the second edge 211. For example, detecting a minimum intensity of the pixels can indicate that each second point lies within the second edge 211 due to pixels of the second edge being the darkest (or having the minimum light intensity) compared to other pixels of the region of interest 202A or rectangular image array 202B.

At operation 490, the processing logic optionally removes one or more of the second points that deviate from a straight line by the threshold percentage, e.g., to ensure that outlier points are excluded form being considered valid points for the second edge 211.

FIG. 5 is a depiction of a substrate 542 having a notch 502 and various orientations and measurements with which to convert the offset to a coordinate system of the robot 102 according to some embodiments. For example, the notch 502 can be oriented in an extension direction of the end effector of the robot 102 on which lies the substrate 542. A slit door 508 can be located opposite from the notch 502 and be in what is referred to as a home position, e.g., where a rotation unit of the substrate support 140 has an output angle of zero degrees (0°). As the substrate 542 can be rotated in a clockwise direction in some embodiments, angle offsets 513 can be determined relative to the location of a gap measurement 509, e.g., which can include the aforementioned edge detection and gap distance determinations.

In embodiments, the control logic 150 determines the angle offset 513 between a rotation unit location and the location of the gap measurement, which can generally span between 60-90 degrees, as illustrated. Once the control logic 150 has determined the angle offset 513, the control logic 150 can determine that the angle offset 513 is the rotation angle 213 (see FIG. 2A) or can determine the rotation angle 213 as 180 degrees minus a value of the angle offset 513, depending on how the insertion axis is defined, e.g., towards the notch 502 or towards the slit door 508.

FIG. 6 is a flow chart of an example method 600 for converting the offset to the coordinate system of the robot 102 according to some embodiments. The method 600 may be performed by processing logic that may include hardware (circuitry, dedicated logic, etc.), software (such as is run on a general purpose computer system or a dedicated machine), firmware, or some combination thereof. For example, the method 600 may be performed by the control logic 150 (or a processing device) of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 610, the processing logic determines a reference angle set within a factory interface aligner (e.g., the FI aligner 101), the reference angle corresponding to a location of a flat or notch 502 of the substrate. In some embodiments, the reference angle is a notch angle relative to the notch 502 illustrated in FIG. 5.

At operation 620, the processing logic rotates each of the X offset value and the Y offset value (of the offset determined at operation 340) by the reference angle to generate a rotated X offset value and a rotated Y offset value of the offset. This rotation can ensure making adjustments to the X and Y offset values corresponding correctly to positioning within the process chamber 104.

At operation 630, the processing logic calculates a distance from a center of the robot to a center of an end effector of the robot when placing the substrate. In some embodiments, this distance is referred to as a circumference, which is calculated based on an extended extension value of the robot 102. For example, the circumference “distance” can be calculated as 2π times the extended extension value.

At operation 640, the processing logic calculates a robot rotation value by translating the rotated X offset value into the robot rotation value by dividing the rotated X offset value by 360 times the distance (e.g., the circumference). This robot rotation value enables the robot 102 to correct for the rotation to align properly, e.g., which in turn enables correctly centering the substrate on the substrate support.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A system comprising:
a substrate support configured to support and rotate a substrate;
a sensor positioned above the substrate support; and
control logic configured to:
cause the sensor to generate a plurality of images of an area of the substrate support and a portion of the substrate in a field of view of the sensor during rotation of the substrate support;
perform edge detection using the plurality of images to identify a first edge of the substrate and a second edge of the substrate support, wherein performing the edge detection using an image comprises, for each of a plurality of scan lines within a region of interest in the image, determining a first point representing the first edge of the substrate and a second point representing the second edge of the substrate support based on applying one or more intensity thresholds;
generate data representing a gap distance between the first edge and the second edge over time;
determine, from the data, a magnitude and a direction of an offset between a first center of the substrate and a second center of the substrate support;
convert the offset to a set of coordinates within a coordinate system of a robot that places the substrate; and
provide the set of coordinates to the robot for use in centering a next substrate on the substrate support.

2. The system of claim 1, further comprising a camera system comprising:
the sensor coupled to a light source;
a borescope comprising a lengthened lens oriented towards the substrate support; and
an infrared filter attached to a bottom of the borescope.

3. The system of claim 1, wherein the control logic is further to identify the region of interest as a sub-area, located at edges of the substrate support and the substrate, having a uniform lamp reflection from heat lamps of a process chamber.

4. The system of claim 1, wherein the offset comprises an X offset value and a Y offset value, and wherein, to convert the offset, the logic is further to:
determine a reference angle set within a factory interface aligner, the reference angle corresponding to a location of a flat or notch of the substrate; and
rotate each of the X offset value and the Y offset value by the reference angle to generate a rotated X offset value and a rotated Y offset value.

5. The system of claim 4, wherein the control logic is further to:
calculate a distance from a center of the robot to a center of an end effector of the robot when placing the substrate; and
calculate a robot rotation value by translating the rotated X offset value into the robot rotation value by dividing the rotated X offset value by 360 times the distance.

6. The system of claim 1, wherein, to determine the magnitude of the offset, the control logic is to:
calculate a plurality of offset values between first points of the first edge and corresponding second points of the second edge;
average the plurality of offset values; and
multiply the averaged value by a scaling factor to convert from pixels to a distance value.

7. The system of claim 1, wherein, to perform edge detection, the control logic is further to:
determine a rotation angle from an insertion axis of the substrate to the region of interest;
rotate the image by the rotation angle to create a rectangular image array;
identify the plurality of scan lines across the rectangular image array; and
filter each scan line using an averaging filter followed by a linear interpolation of each scan line to increase an effective resolution of each scan line.

8. The system of claim 1, wherein the control logic is further to, for each scan line:
scan pixels of the scan line from a substrate side to a substrate support side of the region of interest;
identify the first point on the first edge upon detecting a threshold drop in intensity of the pixels, wherein a combination of first points forms the first edge; and
identify a second point on the second edge upon detecting a minimum intensity of the pixels, wherein a combination of second points forms the second edge.

9. The system of claim 8, wherein the control logic is further to at least one of:
remove one or more of the first points that deviate from a straight line by a threshold percentage; or
remove one or more of the second points that deviate from a straight line by the threshold percentage.

10. A method comprising:
causing, by control logic of a processing system, a sensor to generate a plurality of images of an area of a substrate support and a portion of a substrate in a field of view of the sensor during rotation of the substrate support;
performing, by the control logic, edge detection using the plurality of images to identify a first edge of the substrate and a second edge of the substrate support, wherein performing the edge detection using an image comprises, for each of a plurality of scan lines within a region of interest in the image, determining a first point representing the first edge of the substrate and a second point representing the second edge of the substrate support based on applying one or more intensity thresholds;
generating data representing a gap distance between the first edge and the second edge over time;
determining, from the data, a magnitude and a direction of an offset between a first center of the substrate and a second center of the substrate support;
converting the offset to a set of coordinates within a coordinate system of a robot that places the substrate; and
providing, by the control logic, the set of coordinates to the robot for use in centering a next substrate on the substrate support.

11. The method of claim 10, further comprising identifying the region of interest as a sub-area, located at edges of the substrate support and the substrate, having a uniform lamp reflection from heat lamps of a process chamber.

12. The method of claim 10, wherein the offset comprises an X offset value and a Y offset value, and wherein converting the offset comprises:
determining a reference angle set within a factory interface aligner, the reference angle corresponding to a location of a flat or notch of the substrate; and
rotating each of the X offset value and the Y offset value by the reference angle to generate a rotated X offset value and a rotated Y offset value.

13. The method of claim 12, further comprising:
calculating a distance from a center of the robot to a center of an end effector of the robot when placing the substrate; and
calculating a robot rotation value by translating the rotated X offset value into the robot rotation value by dividing the rotated X offset value by 360 times the distance.

14. The method of claim 10, wherein determining the magnitude of the offset comprises:
calculating a plurality of offset values between first points of the first edge and corresponding second points of the second edge;
averaging the plurality of offset values; and
multiplying the averaged value by a scaling factor to convert from pixels to a distance value.

15. The method of claim 10, wherein performing the edge detection further comprises:
determine a rotation angle from an insertion axis of the substrate to the region of interest;
rotate the image by the rotation angle to create a rectangular image array;
identifying the plurality of scan lines across the rectangular image array; and
filtering each scan line using an averaging filter followed by a linear interpolation of each scan line to increase an effective resolution of each scan line.

16. The method of claim 10, further comprising, for each scan line:
scanning pixels of the scan line from a substrate side to a substrate support side of the region of interest;
identifying the first point on the first edge upon detecting a threshold drop in intensity of the pixels, wherein a combination of first points forms the first edge; and
identifying a second point on the second edge upon detecting a minimum intensity of the pixels, wherein a combination of second points forms the second edge.

17. The method of claim 16, further comprising at least one of:
removing one or more of the first points that deviate from a straight line by a threshold percentage; or
removing one or more of the second points that deviate from a straight line by the threshold percentage.

18. A non-transitory computer-readable storage medium storing instructions, which when executed by a processing device of a processing system, causes the processing device to perform operations comprising:
causing a sensor to generate a plurality of images of an area of a substrate support and a portion of a substrate in a field of view of the sensor during rotation of the substrate support;
performing edge detection using the plurality of images to identify a first edge of the substrate and a second edge of the substrate support, wherein performing the edge detection using an image comprises, for each of a plurality of scan lines within a region of interest in the image, determining a first point representing the first edge of the substrate and a second point representing the second edge of the substrate support based on applying one or more intensity thresholds;
generating data representing a gap distance between the first edge and the second edge over time;
determining, from the data, a magnitude and a direction of an offset between a first center of the substrate and a second center of the substrate support;
converting the offset to a set of coordinates within a coordinate system of a robot that places the substrate; and
providing the set of coordinates to the robot for use in centering a next substrate on the substrate support.

19. The non-transitory computer-readable storage medium of claim 18, wherein the operations further comprise identifying the region of interest as a sub-area, located at edges of the substrate support and the substrate, having a uniform lamp reflection from heat lamps of a process chamber.

20. The non-transitory computer-readable storage medium of claim 18, wherein the offset comprises an X offset value and a Y offset value, and wherein converting the offset comprises:
determining a reference angle set within a factory interface aligner, the reference angle corresponding to a location of a flat or notch of the substrate;
rotating each of the X offset value and the Y offset value by the rotation angle to generate a rotated X offset value and a rotated Y offset value;
calculating a distance from a center of the robot to a center of an end effector of the robot when placing the substrate; and
calculating a robot rotation value by translating the rotated X offset value into the robot rotation value by dividing the rotated X offset value by 360 times the distance.
